(19) United States
(12) Patent Application Publication
(10) Pub. No.: US 2026/0175242 A1
(43) Pub. Date: Jun. 25, 2026

(54) ULTRASONIC CLEANING DEVICE, POWDER COATING COMPONENTS IMPLEMENTING AN ULTRASONIC CLEANING DEVICE AND PROCESSES OF IMPLEMENTING THE SAME

(71) Applicant: NORDSON CORPORATION, WESTLAKE, OH (US)

(72) Inventor: Asim ALTIN, Erkrath (DE)

(73) Assignee: NORDSON CORPORATION, WESTLAKE, OH (US)

(21) Appl. No.: 19/124,473

(22) PCT Filed: Oct. 23, 2023
(86) PCT No.: PCT/US2023/077511

§ 371 Date: Apr. 25, 2025

Related U.S. Application Data
(60) Provisional application No. 63/420,802, filed on Oct. 31, 2022.

(51) Int. Cl. B05B 7/14; B08B 3/12; B08B 5/02; B22F 10/28

(52) U.S. Cl. CPC B05B 7/1445; B05B 7/1472; B08B 3/12; B08B 5/02; B22F 10/28

(57) ABSTRACT

A powder application system cleaning device includes an excitation device. The powder application system cleaning device in addition includes the excitation device being configured to discharge ultrasonic energy to components of the powder application system that will minimize powder accumulation and/or contamination.

### CROSS-REFERENCE TO RELATED APPLICATIONS

This application is a National Stage Application of International Patent App. No. PCT/US2023/077511, filed Oct. 23, 2023, which claims the benefit of U.S. Provisional Patent App. No. 63/420,802, filed Oct. 31, 2022, the entire disclosures of both of which are hereby incorporated by reference as if set forth in their entirety herein.

### FIELD OF THE DISCLOSURE

The disclosure relates to an ultrasonic cleaning device. In particular, an ultrasonic cleaning device configured for cleaning powder coating components. The disclosure further relates to powder coating components implementing an ultrasonic cleaning device for cleaning the powder coating components. Additionally, the disclosure relates to processes of implementing an ultrasonic cleaning device. In particular, processes of implementing an ultrasonic cleaning device configured for cleaning powder coating components. The disclosure further relates to processes of implementing powder coating components implementing an ultrasonic cleaning device for cleaning the powder coating components.

### BACKGROUND OF THE DISCLOSURE

Powder coating materials are typically applied to objects or workpieces by spray application apparatuses and processes. These spray application apparatuses and processes include electrostatic and non-electrostatic processes. Spray application of powder coating material from a feed center or supply to workpieces often is done in a spray booth that is used to contain and recover powder overspray that does not adhere to the workpieces during a powder coating operation. Powder supply systems for such powder installations are used for fluidizing powder and for supplying the fluidized powder to powder spray devices such as powder spray guns or the like. In typical high-performance industrial powder coating installations, a number of powder spray devices or groups thereof can be supplied by a common powder supply system, often referred to as a so-called powder feed center.

Such powder feed centers typically include a powder supply hopper, which is used to supply the powder to this spray device. The powder in the hopper is fluidized by means of a powder fluidizing device associated with the hopper. A powder pump conveys powder from the hopper to the spray device. When a color change is desired, an operator is required to initiate a purging procedure in order to purge and clean the hopper, powder supply lines of the system including for example powder supply lines connecting the hopper, the spray devices, and/or other powder application components. It is a general desire to perform the cleaning and other handling operation during a powder change as quickly, reliably and completely as possible.

However, the typical process requires a highly sophisticated automation solution that requires high air-consumption together with a highly intensive manual maintenance process for each of the powder application components needing cleaning. In particular, typical powder application components are cleaned using pressurized air. For example, using pressured air (6-7 bar, 150-200 Nm³/h) to clean hopper inner walls followed with manual interaction from an operator with a blow gun. In this regard, the time needed for cleaning the hopper may take 4-6 minutes or more. Further, the pressurized air consumes a great deal of energy. Moreover, during the cleaning, the powder application system may have to be partially if not fully inoperative, which reduces productivity and thus increases costs. Thus, the typical process is costly, consumes energy, requires manual interaction, and/or the like.

Accordingly, what is needed a device and process to implement cleaning of powder application components that is quicker, less costly, more energy-efficient, requires less manual interaction, and/or the like.

### SUMMARY OF THE DISCLOSURE

The foregoing needs are met, to a great extent, by the disclosure, wherein in one aspect a technique and apparatus are provided the disclosed ultrasonic cleaning device, the disclosed ultrasonic cleaning device configured for cleaning powder coating components, the disclosed powder coating components implementing an ultrasonic cleaning device for cleaning the powder coating components, the disclosed processes of implementing an ultrasonic cleaning device, the disclosed processes of implementing an ultrasonic cleaning device configured for cleaning powder coating components, the disclosed processes of implementing powder coating components implementing an ultrasonic cleaning device for cleaning the powder coating components, and/or the like.

In one general aspect, a powder application system cleaning device includes an excitation device. The powder application system cleaning device in addition includes the excitation device being configured to discharge ultrasonic energy to components of the powder application system that will minimize powder accumulation and/or contamination.

In one general aspect, a powder application system cleaning device includes an excitation device. The powder application system cleaning device in addition includes an ultrasonic horn. The powder application system cleaning device moreover includes an ultrasonic controller. The powder application system cleaning device also includes the excitation device being configured to discharge ultrasonic energy to components of the powder application system that will minimize powder accumulation and/or contamination.

In one general aspect, a process includes providing an excitation device. The process in addition includes configuring the excitation device to discharge ultrasonic energy to components of the powder application system that will minimize powder accumulation and/or contamination.

In one general aspect, a process includes providing an excitation device. The process in addition includes providing an ultrasonic horn. The process moreover includes providing an ultrasonic controller. The process also includes configuring the excitation device to discharge ultrasonic energy to components of the powder application system that will minimize powder accumulation and/or contamination.

There has thus been outlined, rather broadly, certain aspects of the disclosure in order that the detailed description thereof herein may be better understood, and in order that the present contribution to the art may be better appreciated. There are, of course, additional aspects of the disclosure that will be described below and which will form the subject matter of the claims appended hereto.

In this respect, before explaining at least one aspect of the disclosure in detail, it is to be understood that the disclosure is not limited in its application to the details of construction and to the arrangements of the components set forth in the following description or illustrated in the drawings. The disclosure is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the disclosure. It is important, therefore, that the claims be regarded as including such equivalent constructions insofar as they do not depart from the spirit and scope of the disclosure.

### BRIEF DESCRIPTION OF THE DRAWINGS

FIG. 1 illustrates a powder application system cleaning device implemented in components of a powder application system according to aspects of the disclosure.

FIG. 2 illustrates a powder application system cleaning device implemented according to aspects of the disclosure.

FIG. 3 illustrates an exemplary implementation of powder application system cleaning device implemented in the spray booth according to aspects of the disclosure.

FIG. 4 illustrates an exemplary implementation of powder application system cleaning device implemented in the powder supply hopper according to aspects of the disclosure.

FIG. 5 illustrates an exemplary implementation of powder application system cleaning device implemented in the powder supply hopper according to FIG. 4.

FIG. 6 illustrates an exemplary implementation of powder application system cleaning device implemented in the filter device according to aspects of the disclosure.

FIG. 7 illustrates an exemplary implementation of powder application system cleaning device implemented in the powder recovery system 214 according to aspects of the disclosure.

FIG. 8 illustrates a process of implementing the powder application system cleaning device according to aspects of the disclosure.

### DETAILED DESCRIPTION

The disclosure will now be described with reference to the drawing figures, in which like reference numerals refer to like parts throughout. Aspects of the disclosure advantageously provide a device and process to implement cleaning of powder application system components that is quicker, less costly, more energy-efficient, requires less manual interaction, and/or the like.

A powder feed center may include one or multiple hoppers that are used for receiving and fluidizing powder coating material from a first powder coating material supply or a virgin powder coating material supply. Moreover, the one or multiple hoppers of the powder feed center may also receive and fluidize previously unused powder coating material from a second powder coating material supply or a reclaim powder coating material supply. The first powder coating material supply may be a box of new powder coating material and the second powder coating material supply may be from a powder overspray recovery system associated with a spray booth or other powder center component. For example, a cyclone separator that supplies reclaimed powder coating material.

In a lower portion of the powder feed hopper may be a fluidizing bed or plate which may be spaced above a bottom wall or floor of the hopper so as to provide a plenum. Pressurized fluidizing air is supplied from an air source to the plenum. In this regard, the fluidizing bed may be porous to air and the fluidizing air produces a volume of fluidized material within the hopper. The hopper may include a plurality of powder outlet ports each of which may be connected by a feed hose to a gun pump. Each gun pump draws fluidized powder, such as dense phase powder, from the hopper and moves the powder to a spray gun at the spray booth.

The powder feed center may have different operation modes such as a color change operation. In this regard, during the color change operation, the powder coating material must be completely from hopper internal volume and surfaces. This operation is typically done by applying additional pressure-air supply for short period of times in pulses or continuous flow of air inside powder hopper. The pressure-air supply may be through a fix connection to hopper or automated air blow-off mechanism, which is moving in and out inside powder hopper. Afterwards, typically the powder hopper is inspected by operator and further manually cleaned by using an additional air-blow off gun.

The disclosed device and process are configured to minimize the following actions during color change operations and/or other cleaning operations: an applied pressured-air for removing powder from powder application system components, such as the inner walls and fluidizing bed of powder hopper; energy usage relating to the cleaning process; a cleaning time of powder application system components, such as the hopper to achieve quick powder material change over; and/or an amount of manual interaction of operators for cleaning powder application system components.

In particular, the disclosed device and process may implement one or multiple ultrasonic probes, also known as a convertor. Further, the one or multiple ultrasonic probes may be mechanically assembled to the powder application system components, such as the powder hopper. Moreover, the one or multiple ultrasonic probes may be connected to an ultrasonic controller, also known as a generator. Further, a high frequency energy may be provided by the generator to be transduced by the convertor into ultrasonic vibrations, which are applied to the powder application system components, such as inner walls of powder hopper or hoppers, which may be applied continuously or discretely. In aspects, a powder coating control system to may apply different parameters during operation, various cleaning operations color change mode operations and/or the like for energy saving. Further, the applied ultrasonic vibrations will keep the powder application system components cleaner, require minimum pressure air to clean or blow-off inner surfaces of the powder application system components during cleaning operations, such as color change mode operations. Further, the disclosed device and process will also minimize a cleaning operation time, a color change time, and/or the like. Moreover, the disclosed device and process will also minimize manual interaction.

In aspects, the disclosed device and process may continuously provide cleaning of powder application system components, such as powder feed hopper walls avoiding powder built-up on the surfaces using an ultrasonic discharging device and method which will allow shortening the color change time as well as other cleaning operations, minimal or reduced usage of pressured air for cleaning powder application system components, such as hopper cleaning. In aspects, an ultrasonic device, an ultrasonic probe, and/or the like may be directly attached to powder application system components, such as a powder feed hopper. In aspects, the ultrasonic device may be operating during any operation, during a color change operation, and/or the like. In aspects, the ultrasonic device may different settings for cleaning.

In aspects, the disclosed device and process of cleaning powder application system components, such as cleaning a powder feeding hopper addresses the issues of high air consumption and longer color changes. In aspects, the disclosed device and process of cleaning powder application system components, may include cleaning a powder booth, a powder booth floor, powder booth walls and/or the like. The disclosed device and process of cleaning powder application system components addresses the issues of high air consumption and longer color changes. Additionally, the disclosed device and process of cleaning powder application system components may allow implementation of different powder booth materials, different powder booth design concepts, and/or the like.

Further, in most powder spray systems, such as electrostatic spray systems, the powder is ejected from a gun nozzle as a cloud. This permits the powder spray to envelope the object and to coat all the surfaces of the object, even when the object is irregular in geometric shape. Moreover, one or more guns may be positioned on different sides of the object and/or directed at different angles to increase the uniformity of the powder applied thereto. However, due to the inherent nature of the powder spray pattern, there is a substantial amount of powder that does not adhere to the object and ends up falling to the floor, collecting on other objects and structures in the immediate area, and/or the like. This non-adherent powder residue is generally referred to as powder overspray.

Because powder overspray is generated during each spraying operation, spraying operations typically are performed within a spray booth. The spray booth is used for powder containment and may only be partially enclosed. Most spray booths have an air flow system that contains the powder overspray within the structure of the booth by producing a negative pressure zone that draws air from the powder booth along with powder overspray that is entrained in the air flow. The powder laden air is then transferred to a cartridge filter system, a cyclone separator system, and/or the like that may be arranged outside the spray booth to recover the powder. However, in known spray booth systems, the powder overspray still tends to collect on the booth walls, booth ceiling, the booth floor, an/or the like. In electrostatic systems especially, the powder overspray will also tend to be attracted to and collect on any structure that is electrically grounded. The powder particles tend to be very small and well dispersed and therefore can collect in the smallest of recesses, seams, crevices, irregular spray booth wall structures, and/or the like.

Besides the challenge of recovering powder overspray for subsequent use or disposal, powder overspray that collects within the spray booth must be removed from the booth when changing over the powder coating color. In order to switch from one color to another color, the guns, booth and powder recovery system, and other powder application system components must be as completely purged of the previous colored powder as possible to prevent contamination of the subsequent colored powder. The color change operation is an ongoing challenge in the art to make spraying systems that are “quick color change” meaning that the goal is to keep reducing the down time when the spraying system is off line in order to clean the spraying apparatus and system. Thus, the amount of in-process powder, as well as the amount of powder overspray that remains in the spray booth, have a significant impact on the amount of time and effort it takes to perform a color change operation.

In typical powder coating systems, to minimize powder accumulation on the booth floor surfaces during a cleaning operation, a color change operation, and/or the like, a floor blow-off system or air-wash system may be integrated to move powder from floor surfaces by air nozzles applying pressure air in different sequences. This increase pressure-air consumption of system. Additionally, in powder coating systems, during a color change mode operation or other cleaning operations, one or multiple operators are needed to clean powder booth inner walls and floor with a blow lance, pipe, gun, and/or the like by applying pressure air to surfaces. This increases pressure-air consumption of system, extends color change time, increases risk contamination of previous color, is not ergonomic for operators, and/or the like.

Accordingly, the disclosed device and process may apply continuously, discretely, temporarily, and/or the like ultrasonic discharge energy to powder application system components, such as a powder booth inner wall, a powder booth floor surface, and/or the like that will minimize powder accumulation and contamination. In aspects, the disclosed device and process may minimize applied pressured-air for removing powder from powder application system components, such as powder booth inner walls, powder booth floors, and/or the like. In aspects, the disclosed device and process may minimize cleaning time of complete system including the various powder application system components described herein. In aspects, the disclosed device and process may minimize contamination risks. In aspects, the disclosed device and process may minimize manual interaction of operators. In aspects, the disclosed device and process may enable the use different powder system component materials, such as materials having lower costs. In aspects, the disclosed device and process may enable the use different powder booth materials, such as materials having lower costs. In aspects, the disclosed device and process may further avoid an additional floor cleaning mechanism, floor blow-off system, and/or the like.

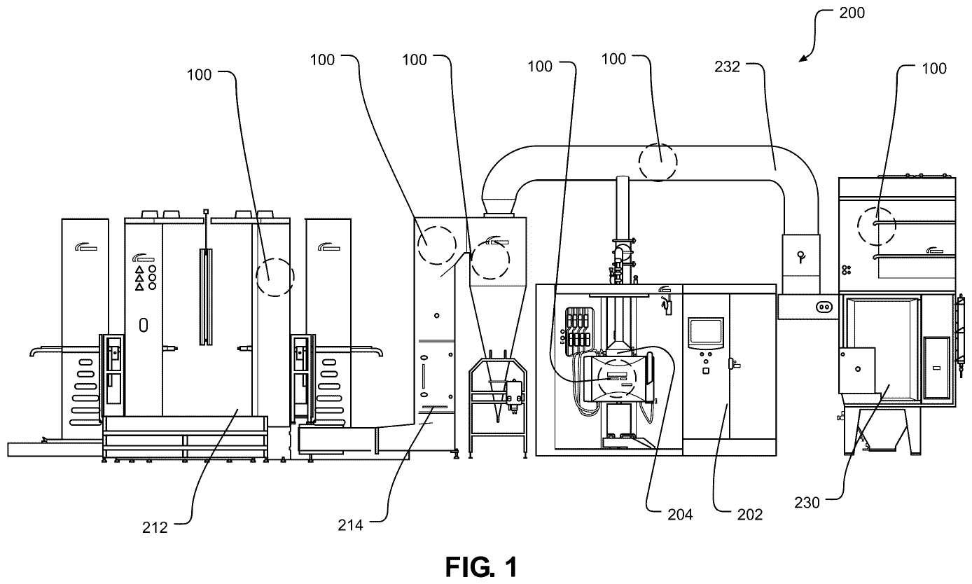

FIG. 1 illustrates a powder application system cleaning device implemented in components of a powder application system according to aspects of the disclosure.

In particular, FIG. 1 illustrates a powder application system cleaning device 100 implemented in components of a powder application system 200 according to aspects of the disclosure. Additionally, the aspects illustrated in FIG. 1 and described in relation thereto, may include any other aspects of the powder application system 200 and the powder application system cleaning device 100 described herein. Further, the aspects illustrated in FIG. 1 and described in relation thereto, may be implemented in any other aspects of the powder application system 200 and the powder application system cleaning device 100 as described and illustrated herein.

In this regard, the powder application system cleaning device 100 may be configured to be implemented in one or more components of the powder application system 200. Further, the powder application system 200 may implement one or more implementations of the powder application system cleaning device 100. In aspects, the powder application system cleaning device 100 may apply continuously, discretely, temporarily, and/or the like ultrasonic discharge energy to components of the powder application system 200 that will minimize powder accumulation, contamination, and/or the like. In aspects, the powder application system cleaning device 100 may minimize the need to apply pressured-air for removing powder from components of the powder application system 200. In aspects, the powder application system cleaning device 100 may minimize cleaning time of components of the powder application system 200. In aspects, the powder application system cleaning device 100 may minimize contamination risks associated with the powder application system 200. In aspects, the powder application system cleaning device 100 may minimize manual interaction of operators to clean various aspects of the powder application system 200. In aspects, the powder application system cleaning device 100 may enable the use different component materials for the powder application system 200, such as materials having lower costs.

With reference to FIG. 1, the powder application system 200 may include a spray booth 212, a powder recovery system 214, a powder supply hopper 204, a powder feed center 202, a filter device 230, a powder line 232, and/or the like.

In aspects, the powder application system cleaning device 100 may be configured to be implemented in the spray booth 212. In aspects, the spray booth 212 may implement one or more implementations of the powder application system cleaning device 100. More specifically, the powder application system cleaning device 100 may apply continuously, discreetly, temporarily, and/or the like ultrasonic discharge energy to components of the spray booth 212 that will minimize powder accumulation and contamination. In aspects, the powder application system cleaning device 100 may minimize the need to apply pressured-air for removing powder from components of the spray booth 212. In aspects, the powder application system cleaning device 100 may minimize cleaning time of components of the spray booth 212. In aspects, the powder application system cleaning device 100 may minimize contamination risks associated with the spray booth 212. In aspects, the powder application system cleaning device 100 may minimize manual interaction of operators to clean various aspects of the spray booth 212. In aspects, the powder application system cleaning device 100 may enable the use different component materials for the spray booth 212, such as materials having lower costs.

In aspects, the powder application system cleaning device 100 may be configured to be implemented in the powder recovery system 214. In aspects, the powder recovery system 214 may implement one or more implementations of the powder application system cleaning device 100. More specifically, the powder application system cleaning device 100 may apply continuously, discretely, temporarily, and/or the like ultrasonic discharge energy to components of the powder recovery system 214 that will minimize powder accumulation and contamination. In aspects, the powder application system cleaning device 100 may minimize the need to apply pressured-air for removing powder from components of the powder recovery system 214. In aspects, the powder application system cleaning device 100 may minimize cleaning time of components of the powder recovery system 214. In aspects, the powder application system cleaning device 100 may minimize contamination risks associated with the powder recovery system 214. In aspects, the powder application system cleaning device 100 may minimize manual interaction of operators to clean various aspects of the powder recovery system 214. In aspects, the powder application system cleaning device 100 may enable the use different component materials for the powder recovery system 214, such as materials having lower costs.

In aspects, the powder application system cleaning device 100 may be configured to be implemented in the powder supply hopper 204. In aspects, the powder supply hopper 204 may implement one or more implementations of the powder application system cleaning device 100. More specifically, the powder application system cleaning device 100 may apply continuously, discreetly, temporarily, and/or the like ultrasonic discharge energy to components of the powder supply hopper 204 that will minimize powder accumulation and contamination. In aspects, the powder application system cleaning device 100 may minimize the need to apply pressured-air for removing powder from components of the powder supply hopper 204. In aspects, the powder application system cleaning device 100 may minimize cleaning time of components of the powder supply hopper 204. In aspects, the powder application system cleaning device 100 may minimize contamination risks associated with the powder supply hopper 204. In aspects, the powder application system cleaning device 100 may minimize manual interaction of operators to clean various aspects of the powder supply hopper 204. In aspects, the powder application system cleaning device 100 may enable the use different component materials for the powder supply hopper 204, such as materials having lower costs.

In aspects, the powder application system cleaning device 100 may be configured to be implemented in the feed center 202. In aspects, the powder feed center 202 may implement one or more implementations of the powder application system cleaning device 100. More specifically, the powder application system cleaning device 100 may apply continuously, discretely, temporarily, and/or the like ultrasonic discharge energy to components of the powder feed center 202 that will minimize powder accumulation and contamination. In aspects, the powder application system cleaning device 100 may minimize the need to apply pressured-air for removing powder from components of the powder feed center 202. In aspects, the powder application system cleaning device 100 may minimize cleaning time of components of the powder feed center 202. In aspects, the powder application system cleaning device 100 may minimize contamination risks associated with the powder feed center 202. In aspects, the powder application system cleaning device 100 may minimize manual interaction of operators to clean various aspects of the powder feed center 202. In aspects, the powder application system cleaning device 100 may enable the use different component materials for the powder feed center 202, such as materials having lower costs.

In aspects, the powder application system cleaning device 100 may be configured to be implemented in the filter device 230. In aspects, the filter device 230 may implement one or more implementations of the powder application system cleaning device 100. More specifically, the powder application system cleaning device 100 may apply continuously, discreetly, temporarily, and/or the like ultrasonic discharge energy to components of the filter device 230 that will minimize powder accumulation and contamination. In aspects, the powder application system cleaning device 100 may minimize the need to apply pressured-air for removing powder from components of the filter device 230. In aspects, the powder application system cleaning device 100 may minimize cleaning time of components of the filter device 230. In aspects, the powder application system cleaning device 100 may minimize contamination risks associated with the filter device 230. In aspects, the powder application system cleaning device 100 may minimize manual interaction of operators to clean various aspects of the filter device 230. In aspects, the powder application system cleaning device 100 may enable the use different component materials for the filter device 230, such as materials having lower costs.

In aspects, the powder application system cleaning device 100 may be configured to be implemented in the powder line 232. In aspects, the powder line 232 may implement one or more implementations of the powder application system cleaning device 100. More specifically, the powder application system cleaning device 100 may apply continuously, discretely, temporarily, and/or the like ultrasonic discharge energy to components of the powder line 232 that will minimize powder accumulation and contamination. In aspects, the powder application system cleaning device 100 may minimize the need to apply pressured-air for removing powder from components of the powder line 232. In aspects, the powder application system cleaning device 100 may minimize cleaning time of components of the powder line 232. In aspects, the powder application system cleaning device 100 may minimize contamination risks associated with the powder line 232. In aspects, the powder application system cleaning device 100 may minimize manual interaction of operators to clean various aspects of the powder line 232. In aspects, the powder application system cleaning device 100 may enable the use different component materials for the powder line 232, such as materials having lower costs.

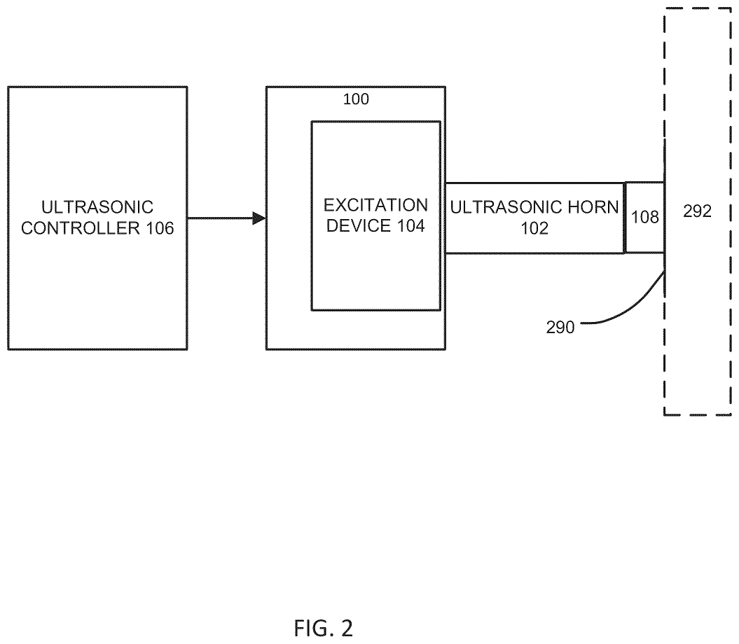

FIG. 2 illustrates a powder application system cleaning device implemented according to aspects of the disclosure.

In particular, FIG. 2 illustrates a powder application system cleaning device 100 implemented according to aspects of the disclosure. Additionally, the aspects illustrated in FIG. 2 and described in relation thereto, may include any other aspects of the powder application system 200 and the powder application system cleaning device 100 described herein. Further, the aspects illustrated in FIG. 2 and described in relation thereto, may be implemented in any other aspects of the powder application system 200 and the powder application system cleaning device 100 as described and illustrated herein.

The powder application system cleaning device 100 may include an ultrasonic horn 102, an excitation device 104, an ultrasonic controller 106, and/or the like. The ultrasonic horn 102 may be located on a component 292 of the powder application system 200, in the component 292 of the powder application system 200, adjacent the component 292 of the powder application system 200, and/or the like.

In aspects, the ultrasonic horn 102 may be attached to a surface 290 of a component of the powder application system 200 by an adhesive, by welding, by mechanical fasteners, by one or more magnets, and/or the like. In aspects, the ultrasonic horn 102 may be directly attached to the surface 290. In aspects, the ultrasonic horn 102 may be attached to the surface 290 by one or more intervening attachment structures 108. The one or more intervening attachment structures 108 may be attached to the ultrasonic horn 102 by an adhesive, by welding, by mechanical fasteners, by one or more magnets, and/or the like. The one or more intervening attachment structures 108 may be attached to the surface 290 by an adhesive, by welding, by mechanical fasteners, by one or more magnets, and/or the like.

In aspects, upon excitation by ultrasonic energy by the powder application system cleaning device 100, the powder application system cleaning device 100 may be configured to apply ultrasonic energy to the surface 290 of the component of the powder application system 200. The excitation device 104 may be implemented as a piezoelectric transducer, a magnetostrictive transducer, and/or the like. In aspects, the excitation device 104 may be implemented as piezoelectric device with lead zirconate titanate (PZT), barium titanate, and/or the like. The excitation device 104 may be coupled to the ultrasonic horn 102 along its longitudinal axis. The coupling may be a direct coupling, through an elongated waveguide, and/or the like. In aspects, the ultrasonic horn 102 may be attached to the excitation device 104 by an adhesive, by welding, by mechanical fasteners, by one or more magnets, and/or the like. In aspects, the ultrasonic horn 102 may be directly attached to the excitation device 104. In aspects, the ultrasonic horn 102 may be attached to the excitation device 104 by one or more intervening attachment structures by an adhesive, by welding, by mechanical fasteners, by one or more magnets, and/or the like.

Applying by the ultrasonic horn 102 an excitation frequency of between 15 KHz to 500 KHz generated by the powder application system cleaning device 100 and/or the ultrasonic controller 106 will result in the vibrating and focusing of ultrasonic energy at desired region of the component 292 of the powder application system 200. Various alternative techniques for implementing an ultrasonic transducer or horn are also within the scope of the disclosure.

The powder application system cleaning device 100 may be configured to convert the sound energy of the excitation device 104 into mechanical vibration by the ultrasonic horn 102. The vibration generated by the ultrasonic horn 102 and/or the excitation device 104 may generate an ultrasonic wave that may be transmitted to the component 292 of the powder application system cleaning device 100 under the action of a sound wave causing the powder on the surface 290 of the component 292 of the powder application system cleaning device 100 to separate from the surface 290 of the component 292 of the powder application system cleaning device 100.

In aspects, the ultrasonic controller 106 may be configured to provide energy to the powder application system cleaning device 100 to provide a continuous predetermined ultrasonic frequency to the surface 290 of the component 292. In aspects, the ultrasonic controller 106 may be configured to provide energy to the powder application system cleaning device 100 to provide a discrete predetermined ultrasonic frequency to the surface 290 of the component 292.

In aspects, the ultrasonic controller 106 may be configured to provide energy to the powder application system cleaning device 100 to provide a controllable ultrasonic frequency to the surface 290 of the component 292. In aspects, the ultrasonic controller 106 may be configured to provide energy to the powder application system cleaning device 100 to provide a varying or sweeping ultrasonic frequency to the surface 290 of the component 292.

In particular, the powder application system cleaning device 100 may implement one or multiple ultrasonic probes, also known as a convertor. Further, the powder application system cleaning device 100 may be mechanically assembled to components of the powder application system 200. Moreover, the powder application system cleaning device 100 may be connected to the excitation device 104, also known as a generator. Further, a high frequency energy may be provided by the excitation device 104 to be transduced by the ultrasonic horn 102 into ultrasonic vibrations, which are applied to components of the powder application system 200. In aspects, the powder application system cleaning device 100 and/or the ultrasonic controller 106 may apply different parameters during operation, various cleaning operations, color change mode operations and/or the like for energy saving. Further, the applied ultrasonic vibrations from the powder application system cleaning device 100 may keep components of the powder application system 200 cleaner, require minimum pressure air to clean or blow-off inner surfaces of components of the powder application system 200 during cleaning operations, such as color change mode operations. Further, the powder application system cleaning device 100 will also minimize a cleaning operation time, a color change time, and/or the like. Moreover, the powder application system cleaning device 100 will also minimize manual interaction.

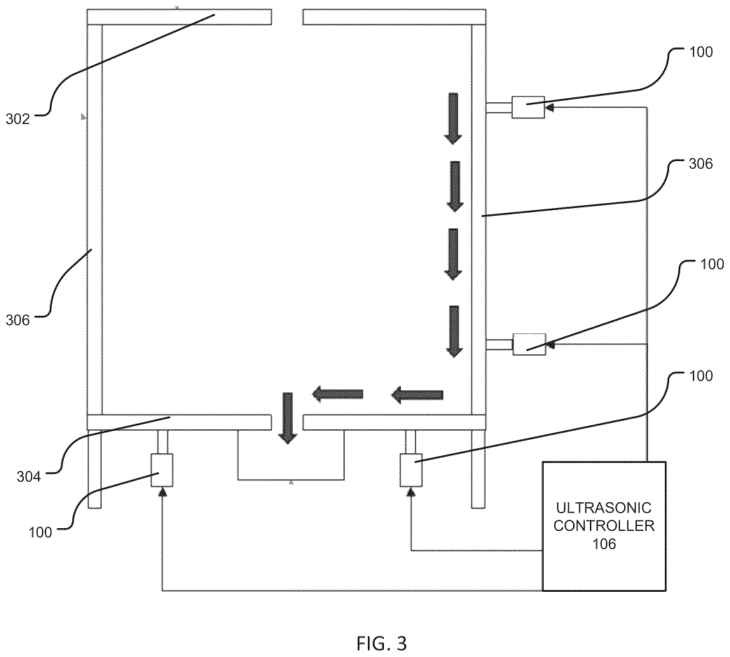

FIG. 3 illustrates an exemplary implementation of powder application system cleaning device implemented in the spray booth according to aspects of the disclosure.

In aspects, the powder application system cleaning device 100 may be configured to be implemented in the spray booth 212. In particular, FIG. 3 illustrates an exemplary implementation of powder application system cleaning device implemented in the spray booth 212 according to aspects of the disclosure. Additionally, the aspects illustrated in FIG. 3 and described in relation thereto, may include any other aspects of the powder application system 200 and the powder application system cleaning device 100 described herein. Further, the aspects illustrated in FIG. 3 and described in relation thereto, may be implemented in any other aspects of the powder application system 200 and the powder application system cleaning device 100 as described and illustrated herein.

In aspects, the powder application system cleaning device 100 may be attached to any portion or component of the spray booth 212 at various locations. For example, the powder application system cleaning device 100 may be attached to external portions, external surfaces, internal portions, internal surfaces, and/or the like of the spray booth 212. The attachment of the powder application system cleaning device 100 to the spray booth 212 may be through the ultrasonic horn 102 and/or the one or more intervening attachment structures 108. Moreover, there may be a plurality of implementations of the powder application system cleaning device 100 attached to the spray booth 212 at various locations. Each implementation of the powder application system cleaning device 100 may be connected to and controlled by the ultrasonic controller 106. Accordingly, powder temporarily adhered to the spray booth 212 may be subjected to ultrasonic energy from the powder application system cleaning device 100 and accordingly the powder may be cleaned from and/or removed from the spray booth 212.

In particular, FIG. 3 illustrates an exemplary implementation of powder application system cleaning device 100 implemented in the spray booth 212 according to aspects of the disclosure. In this regard, the spray booth 212 may include a roof 302, a floor 304, one or more walls 306, and/or the like.

In aspects, the powder application system cleaning device 100 may be attached to the roof 302 of the spray booth 212 at various locations. For example, the powder application system cleaning device 100 may be attached to external portions, external surfaces, internal portions, internal surfaces, and/or the like of the roof 302 of the spray booth 212. The attachment of the powder application system cleaning device 100 to the roof 302 may be through the ultrasonic horn 102 and/or the one or more intervening attachment structures 108. Moreover, there may be a plurality of implementations of the powder application system cleaning device 100 attached to the roof 302 of the spray booth 212 at various locations. Each implementation of the powder application system cleaning device 100 may be connected to and controlled by the ultrasonic controller 106. Accordingly, powder temporarily adhered to the roof 302 may be subjected to ultrasonic energy from the powder application system cleaning device 100 and accordingly the powder may be cleaned from and/or removed from the roof 302 of the spray booth 212.

In aspects, the powder application system cleaning device 100 may be attached to the floor 304 of the spray booth 212 at various locations. For example, the powder application system cleaning device 100 may be attached to external portions, external surfaces, internal portions, internal surfaces, and/or the like of the floor 304 of the spray booth 212. The attachment of the powder application system cleaning device 100 to the floor 304 may be through the ultrasonic horn 102 and/or the one or more intervening attachment structures 108. Moreover, there may be a plurality of implementations of the powder application system cleaning device 100 attached to the floor 304 of the spray booth 212 at various locations. Each implementation of the powder application system cleaning device 100 may be connected to and controlled by the ultrasonic controller 106. Accordingly, powder temporarily adhered to the floor 304 may be subjected to ultrasonic energy from the powder application system cleaning device 100 and accordingly the powder may be cleaned from and/or removed from the floor 304 of the spray booth 212.

In aspects, the powder application system cleaning device 100 may be attached to the one or more walls 306 of the spray booth 212 at various locations. For example, the powder application system cleaning device 100 may be attached to external portions, external surfaces, internal portions, internal surfaces, and/or the like of the one or more walls 306 of the spray booth 212. The attachment of the powder application system cleaning device 100 to the one or more walls 306 may be through the ultrasonic horn 102 and/or the one or more intervening attachment structures 108. Moreover, there may be a plurality of implementations of the powder application system cleaning device 100 attached to the one or more walls 306 of the spray booth 212 at various locations. Each implementation of the powder application system cleaning device 100 may be connected to and controlled by the ultrasonic controller 106. Accordingly, powder temporarily adhered to the one or more walls 306 may be subjected to ultrasonic energy from the powder application system cleaning device 100 and accordingly the powder may be cleaned from and/or removed from the one or more walls 306 of the spray booth 212 as shown by the arrows.

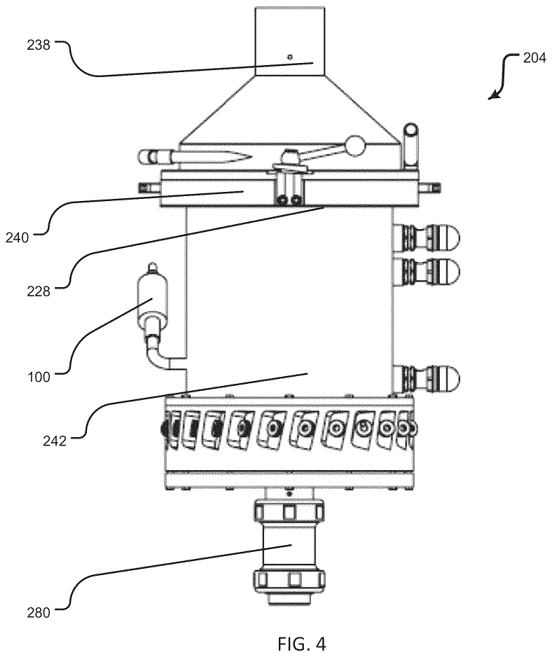

FIG. 4 illustrates an exemplary implementation of powder application system cleaning device implemented in the powder supply hopper according to aspects of the disclosure.

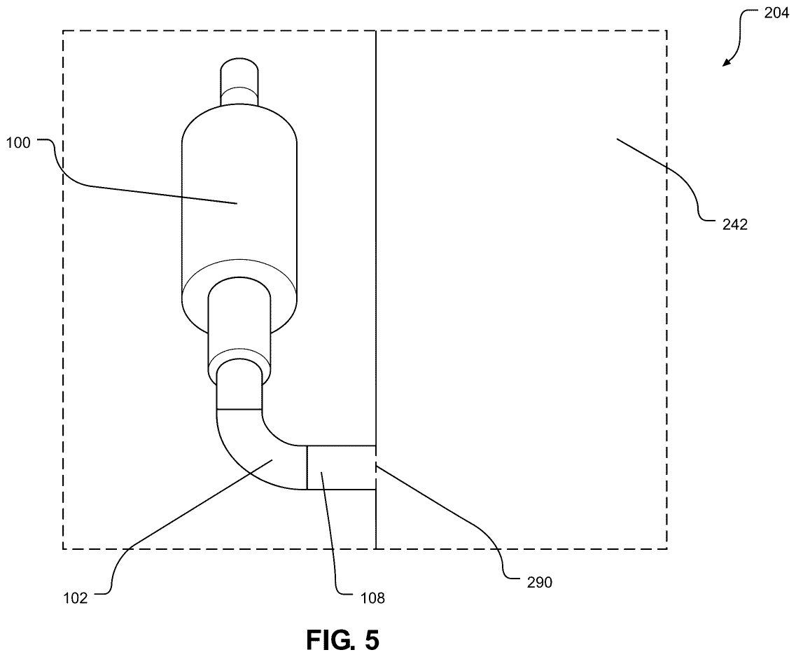

FIG. 5 illustrates an exemplary implementation of powder application system cleaning device implemented in the powder supply hopper according to FIG. 4.

In particular, FIG. 4 illustrates an exemplary implementation of powder application system cleaning device 100 implemented in the powder supply hopper 204 according to aspects of the disclosure. Additionally, the aspects illustrated in FIG. 4 and described in relation thereto, may include any other aspects of the powder application system 200 and the powder application system cleaning device 100 described herein. Further, the aspects illustrated in FIG. 4 and described in relation thereto, may be implemented in any other aspects of the powder application system 200 and the powder application system cleaning device 100 as described and illustrated herein.

In aspects, the powder application system cleaning device 100 may be configured to be attached to any portion or component of the powder supply hopper 204 at various locations. For example, the powder application system cleaning device 100 may be attached to external portions, external surfaces, internal portions, internal surfaces, and/or the like of the powder supply hopper 204. The attachment of the powder application system cleaning device 100 to the powder supply hopper 204 may be through the ultrasonic horn 102 and/or the one or more intervening attachment structures 108 as illustrated in FIG. 5. Moreover, there may be a plurality of implementations of the powder application system cleaning device 100 attached to the powder supply hopper 204 at various locations. Each implementation of the powder application system cleaning device 100 may be connected to and controlled by the ultrasonic controller 106. Accordingly, powder temporarily adhered to the powder supply hopper 204 may be subjected to ultrasonic energy from the powder application system cleaning device 100 and accordingly the powder may be cleaned from and/or removed from the powder supply hopper 204.

With reference to FIG. 4, the powder supply hopper 204 may include a hopper wall 242, a lid 240, an outlet port 238, an outlet port 280, a top opening 228, and/or the like.

In aspects, the powder application system cleaning device 100 may be configured to be attached to the hopper wall 242 of the powder supply hopper 204 at various locations as illustrated in FIG. 4 and FIG. 5. For example, the powder application system cleaning device 100 may be attached to external portions, external surfaces, internal portions, internal surfaces, and/or the like of the hopper wall 242 of the powder supply hopper 204. As illustrated in FIG. 4 and FIG. 5, the powder application system cleaning device 100 may be attached to an external surface of the hopper wall 242 of the powder supply hopper 204. The attachment of the powder application system cleaning device 100 to the hopper wall 242 may be through the ultrasonic horn 102 and/or the one or more intervening attachment structures 108. Moreover, there may be a plurality of implementations of the powder application system cleaning device 100 attached to the hopper wall 242 of the powder supply hopper 204 at various locations. Each implementation of the powder application system cleaning device 100 may be connected to and controlled by the ultrasonic controller 106. Accordingly, powder temporarily adhered to the hopper wall 242 may be subjected to ultrasonic energy from the powder application system cleaning device 100 and accordingly the powder may be cleaned from and/or removed from the hopper wall 242 of the powder supply hopper 204. In this regard, the hopper wall 242 of the powder supply hopper 204 may have a cylindrical construction as illustrated in FIG. 4. In other aspects, the hopper wall 242 of the powder supply hopper 204 may have a square shaped construction, a rectangular shaped construction, and/or the like.

In aspects, the powder application system cleaning device 100 may be configured to be attached to the lid 240 of the powder supply hopper 204 at various locations. For example, the powder application system cleaning device 100 may be attached to external portions, external surfaces, internal portions, internal surfaces, and/or the like of the lid 240 of the powder supply hopper 204. The attachment of the powder application system cleaning device 100 to the lid 240 may be through the ultrasonic horn 102 and/or the one or more intervening attachment structures 108. Moreover, there may be a plurality of implementations of the powder application system cleaning device 100 attached to the lid 240 of the powder supply hopper 204 at various locations. Each implementation of the powder application system cleaning device 100 may be connected to and controlled by the ultrasonic controller 106. Accordingly, powder temporarily adhered to the lid 240 may be subjected to ultrasonic energy from the powder application system cleaning device 100 and accordingly the powder may be cleaned from and/or removed from the lid 240 of the powder supply hopper 204.

Within the lid 240 of the powder supply hopper 204, a sieve or screen may be positioned within a housing of the powder supply hopper 204. The sieve may be positioned at a lower section of the housing of the powder supply hopper 204. Fresh or virgin powder entering the powder supply hopper 204 may flow downwardly towards the sieve. The sieve results in an even powder particle distribution within the powder supply hopper 204.

The powder application system 200 and/or the powder supply hopper 204 may further include a powder fluidizing device for fluidizing powder within the powder supply hopper 204. The powder fluidizing device is not shown in detail. The powder fluidizing device may include a pressure gas source and at least one pressure gas line which is connected to an inlet port, through which pressurized gas, in particular air flows into the powder supply hopper 204. The pressurized gas flows into a fluidizing plenum formed between the bottom of the powder supply hopper 204 and a porous fluidizing plate positioned above bottom. The gas is distributed through the fluidizing plate into the powder supply hopper 204 and flows upwardly therein, so that powder which has been supplied into the powder supply hopper 204 is fluidized. During the operation, the gas can flow out through the outlet opening of the powder supply hopper 204 and out of the powder supply hopper 204 through an outlet port 238.

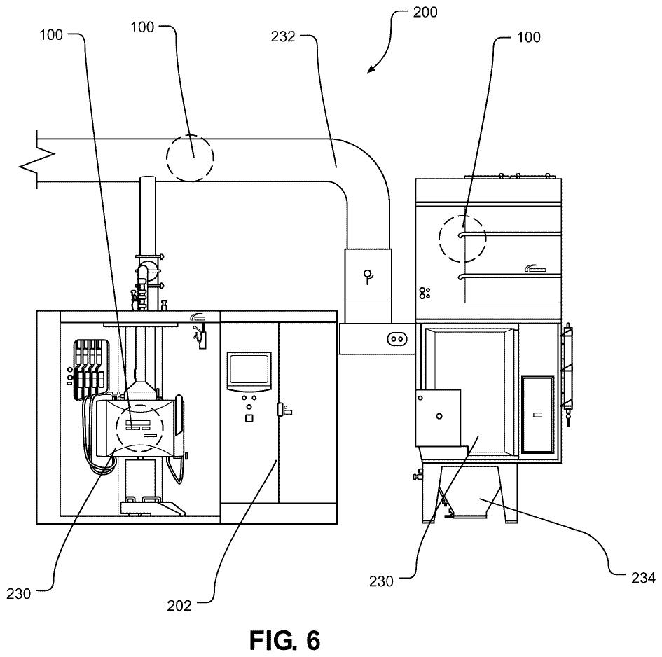

FIG. 6 illustrates an exemplary implementation of powder application system cleaning device implemented in the filter device according to aspects of the disclosure.

In particular, FIG. 6 illustrates an exemplary implementation of powder application system cleaning device 100 implemented in the filter device 230 according to aspects of the disclosure. Additionally, the aspects illustrated in FIG. 6 and described in relation thereto, may include any other aspects of the powder application system 200 and the powder application system cleaning device 100 described herein. Further, the aspects illustrated in FIG. 6 and described in relation thereto, may be implemented in any other aspects of the powder application system 200 and the powder application system cleaning device 100 as described and illustrated herein.

In aspects, the powder application system cleaning device 100 may be configured to be attached to any portion or component of the filter device 230 at various locations. For example, the powder application system cleaning device 100 may be attached to external portions, external surfaces, internal portions, internal surfaces, and/or the like of the filter device 230. The attachment of the powder application system cleaning device 100 to the filter device 230 may be through the ultrasonic horn 102 and/or the one or more intervening attachment structures 108. Moreover, there may be a plurality of implementations of the powder application system cleaning device 100 attached to the filter device 230 at various locations. Each implementation of the powder application system cleaning device 100 may be connected to and controlled by the ultrasonic controller 106. Accordingly, powder temporarily adhered to the filter device 230 may be subjected to ultrasonic energy from the powder application system cleaning device 100 and accordingly the powder may be cleaned from and/or removed from the filter device 230.

The filter device 230 may be connected to a vacuum source (not shown) such as vacuum pump or ventilator, so that a pneumatic transport of powder which flows out of the powder supply hopper 204 takes place through the powder line 232 into filter elements of the filter device 230. Powder that is collected in the filter elements can be taken from the filter device 230 by outlets 234.

In aspects, the powder application system cleaning device 100 may be configured to be attached to any portion or component of the powder line 232 at various locations. For example, the powder application system cleaning device 100 may be attached to external portions, external surfaces, internal portions, internal surfaces, and/or the like of the powder line 232. The attachment of the powder application system cleaning device 100 to the powder line 232 may be through the ultrasonic horn 102 and/or the one or more intervening attachment structures 108. Moreover, there may be a plurality of implementations of the powder application system cleaning device 100 attached to the powder line 232 at various locations. Each implementation of the powder application system cleaning device 100 may be connected to and controlled by the ultrasonic controller 106. Accordingly, powder temporarily adhered to the powder line 232 may be subjected to ultrasonic energy from the powder application system cleaning device 100 and accordingly the powder may be cleaned from and/or removed from the powder line 232.

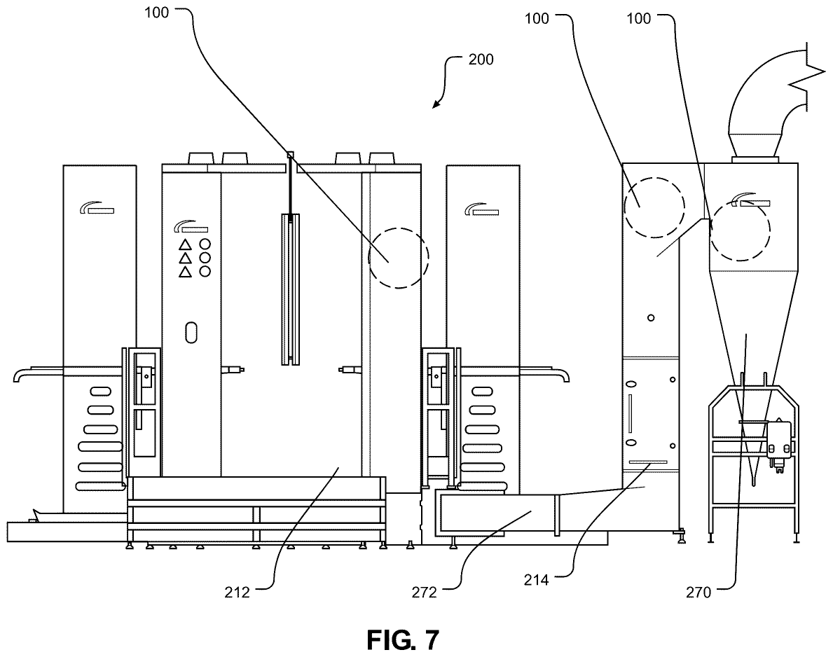

FIG. 7 illustrates an exemplary implementation of powder application system cleaning device implemented in the powder recovery system 214 according to aspects of the disclosure.

In particular, FIG. 7 illustrates an exemplary implementation of powder application system cleaning device 100 implemented in the powder recovery system 214 according to aspects of the disclosure. Additionally, the aspects illustrated in FIG. 7 and described in relation thereto, may include any other aspects of the powder application system 200 and the powder application system cleaning device 100 described herein. Further, the aspects illustrated in FIG. 7 and described in relation thereto, may be implemented in any other aspects of the powder application system 200 and the powder application system cleaning device 100 as described and illustrated herein.

The powder recovery system 214 may include a powder cyclone separator 270, a blower, a suction fan that are in fluid communication through a duct with an exhaust outlet of the powder cyclone separator 270, and provide the energy and air flow required to generate a vortex within the powder cyclone separator 270 for operation of the powder recovery system 214. The fan produces suction that draws a large air flow into the powder cyclone separator 270, in the form of a substantial powder entrained air flow pulled from the spray booth 212 interior, to an intake duct 272 of the powder cyclone separator 270. The powder cyclone separator 270 may include a tangential powder inlet (relative to a vertical axis of the cyclone) to cause the familiar cyclonic circulation or vortex that causes separation of powder coating material from the air. Powder overspray that has been separated by the powder cyclone separator 270 may be recovered from the cyclone outlet and returned to the powder feed center 202.

In aspects, the powder application system cleaning device 100 may be configured to be attached to any portion or component of the powder recovery system 214 at various locations. For example, the powder application system cleaning device 100 may be attached to external portions, external surfaces, internal portions, internal surfaces, and/or the like of the powder recovery system 214. The attachment of the powder application system cleaning device 100 to the powder recovery system 214 may be through the ultrasonic horn 102 and/or the one or more intervening attachment structures 108. Moreover, there may be a plurality of implementations of the powder application system cleaning device 100 attached to the powder recovery system 214 at various locations. Each implementation of the powder application system cleaning device 100 may be connected to and controlled by the ultrasonic controller 106. Accordingly, powder temporarily adhered to the powder recovery system 214 may be subjected to ultrasonic energy from the powder application system cleaning device 100 and accordingly the powder may be cleaned from and/or removed from the powder recovery system 214.

In aspects, the powder application system cleaning device 100 may be configured to be attached to the powder cyclone separator 270 of the powder recovery system 214 at various locations. For example, the powder application system cleaning device 100 may be attached to external portions, external surfaces, internal portions, internal surfaces, and/or the like of the powder cyclone separator 270 of the powder recovery system 214. The attachment of the powder application system cleaning device 100 to the powder cyclone separator 270 may be through the ultrasonic horn 102 and/or the one or more intervening attachment structures 108. Moreover, there may be a plurality of implementations of the powder application system cleaning device 100 attached to the powder cyclone separator 270 of the powder recovery system 214 at various locations. Each implementation of the powder application system cleaning device 100 may be connected to and controlled by the ultrasonic controller 106. Accordingly, powder temporarily adhered to the powder cyclone separator 270 may be subjected to ultrasonic energy from the powder application system cleaning device 100 and accordingly the powder may be cleaned from and/or removed from the powder cyclone separator 270 of the powder recovery system 214.

In aspects, the powder application system cleaning device 100 may be configured to be attached to the intake duct 272 of the powder recovery system 214 at various locations. For example, the powder application system cleaning device 100 may be attached to external portions, external surfaces, internal portions, internal surfaces, and/or the like of the intake duct 272 of the powder recovery system 214. The attachment of the powder application system cleaning device 100 to the intake duct 272 may be through the ultrasonic horn 102 and/or the one or more intervening attachment structures 108. Moreover, there may be a plurality of implementations of the powder application system cleaning device 100 attached to the intake duct 272 of the powder recovery system 214 at various locations. Each implementation of the powder application system cleaning device 100 may be connected to and controlled by the ultrasonic controller 106. Accordingly, powder temporarily adhered to the intake duct 272 may be subjected to ultrasonic energy from the powder application system cleaning device 100 and accordingly the powder may be cleaned from and/or removed from the intake duct 272 of the powder recovery system 214.

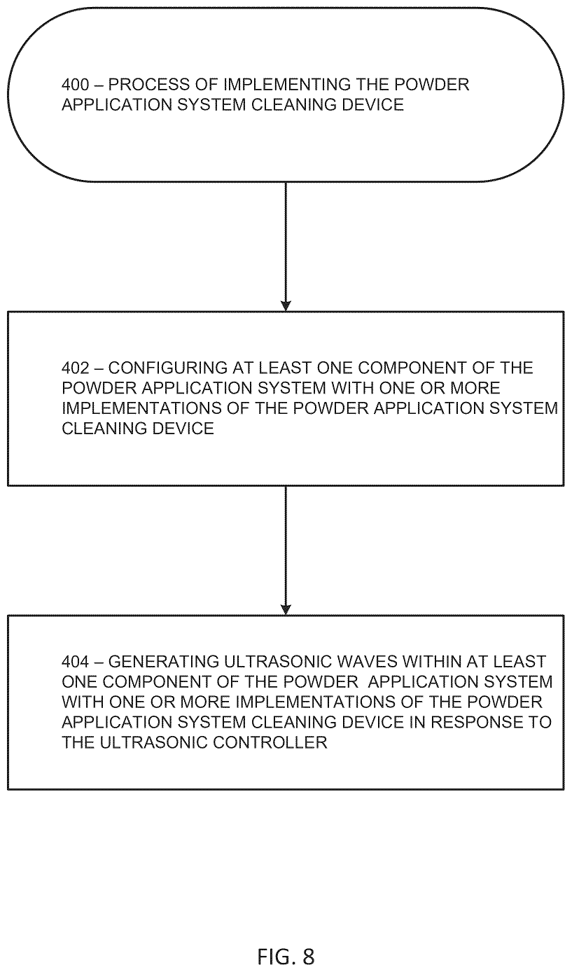

FIG. 8 illustrates a process of implementing the powder application system cleaning device according to aspects of the disclosure.

In particular, FIG. 8 illustrates a process of implementing the powder application system cleaning device 100 according to aspects of the disclosure. Additionally, the aspects illustrated in FIG. 8 and described in relation thereto, may include any other aspects of the powder application system 200 and the powder application system cleaning device 100 described herein. Further, the aspects illustrated in FIG. 8 and described in relation thereto, may be implemented in any other aspects of the powder application system 200 and the powder application system cleaning device 100 as described and illustrated herein.

In particular, FIG. 8 an exemplary process of implementing the powder application system cleaning device 400 of the disclosure. In particular, it should be noted that the process of implementing the powder application system cleaning device 400 is merely exemplary and may be modified consistent with the various aspects disclosed herein. Moreover, the process of implementing the powder application system cleaning device 400 of the disclosure may include a process of manufacturing the powder application system cleaning device 100 and/or the powder application system 200. It should be noted that the process of implementing the powder application system cleaning device 400 may be performed in a different order consistent with the aspects described above. Moreover, the process of implementing the powder application system cleaning device 400 may be modified to have more or fewer process steps consistent with the various aspects disclosed herein.

The process for process of implementing the powder application system cleaning device 400 of the disclosure may configuring at least one component of the powder application system with one or more implementations of the powder application system cleaning device 402. In this regard, the configuring at least one component of the powder application system with one or more implementations of the powder application system cleaning device 402 may include any one or more materials, structures, arrangements, processes, and/or the like as described herein. Moreover, one or more proceeding or subsequent processes may also be implemented with respect to the configuring at least one component of the powder application system with one or more implementations of the powder application system cleaning device 402 consistent with the disclosure. In this regard, the configuring at least one component of the powder application system with one or more implementations of the powder application system cleaning device 402 may include configuring at least one component of the powder application system 200 with one or more implementations of the powder application system cleaning device 100 as described herein.

The process for process of implementing the powder application system cleaning device 400 of the disclosure may include generating ultrasonic waves within at least one component of the powder application system with one or more implementations of the powder application system cleaning device in response to the ultrasonic controller 404. In this regard, the generating ultrasonic waves within at least one component of the powder application system with one or more implementations of the powder application system cleaning device in response to the ultrasonic controller 404 may include any one or more materials, structures, arrangements, processes, and/or the like as described herein. Moreover, one or more proceeding or subsequent processes may also be implemented with respect to the generating ultrasonic waves within at least one component of the powder application system with one or more implementations of the powder application system cleaning device in response to the ultrasonic controller 404 consistent with the disclosure. In this regard, the generating ultrasonic waves within at least one component of the powder application system with one or more implementations of the powder application system cleaning device in response to the ultrasonic controller 404 may include generating ultrasonic waves within at least one component of the powder application system 200 with one or more implementations of the powder application system cleaning device 100 in response to the ultrasonic controller 106 as described herein.

Accordingly, the powder application system 200 implementing the powder application system cleaning device 100 is configured to minimize the following actions during color change operations and/or other cleaning operations: an applied pressured-air for removing powder from powder application system components, such as the inner walls and fluidizing bed of powder hopper; energy usage relating to the cleaning process; a cleaning time of powder application system components, such as the hopper to achieve quick powder material change over; and/or an amount of manual interaction of operators for cleaning powder application system components. Further, the applied ultrasonic vibrations provided by the powder application system cleaning device 100 will keep the components of the powder application system 200 cleaner, require minimum pressure air to clean or blow-off inner surfaces of the powder application system components during cleaning operations, such as color change mode operations. Further, the powder application system 200 implementing the powder application system cleaning device 100 will also minimize a cleaning operation time, a color change time, and/or the like. Moreover, the disclosed device and process will also minimize manual interaction.

The following are a number of nonlimiting EXAMPLES of aspects of the disclosure.

One EXAMPLE includes: a powder application system cleaning device that includes an excitation device. The powder application system cleaning device in addition includes the excitation device being configured to discharge ultrasonic energy to components of the powder application system that will minimize powder accumulation and/or contamination.

The above-noted EXAMPLE may further include any one or a combination of more than one of the following EXAMPLES: The powder application system cleaning device of the above-noted EXAMPLE where the excitation device is configured to provide a continuously, a discretely, and/or a temporarily discharge of ultrasonic energy to components of the powder application system that will minimize powder accumulation and/or contamination. The powder application system cleaning device of the above-noted EXAMPLE where the powder application system may include a spray booth; and where the powder application system cleaning device is configured to be implemented in the spray booth. The powder application system cleaning device of the above-noted EXAMPLE where the powder application system cleaning device is attached to a roof of the spray booth. The powder application system cleaning device of the above-noted EXAMPLE where the powder application system cleaning device is attached to a floor of the spray booth. The powder application system cleaning device of the above-noted EXAMPLE where the powder application system cleaning device is attached to one or more walls of the spray booth. The powder application system cleaning device of the above-noted EXAMPLE where the powder application system cleaning device is attached to a roof of the spray booth; where the powder application system cleaning device is attached to a floor of the spray booth; and where the powder application system cleaning device is attached to one or more walls of the spray booth. The powder application system cleaning device of the above-noted EXAMPLE where the powder application system may include a powder supply hopper; and where the powder application system cleaning device is configured to be implemented in the powder supply hopper. The powder application system cleaning device of the above-noted EXAMPLE where the powder application system cleaning device is configured to be attached to a hopper wall of the powder supply hopper. The powder application system cleaning device of the above-noted EXAMPLE where the powder application system cleaning device is configured to be attached to a lid of the powder supply hopper. The powder application system cleaning device of the above-noted EXAMPLE where the powder application system may include a powder feed center; and where the powder application system cleaning device is configured to be implemented in the powder feed center. The powder application system cleaning device of the above-noted EXAMPLE where the powder application system may include a filter device; and where the powder application system cleaning device is configured to be implemented in the filter device. The powder application system cleaning device of the above-noted EXAMPLE may include: an ultrasonic horn; and an ultrasonic controller. The powder application system cleaning device of the above-noted EXAMPLE where the ultrasonic horn is located on a component of the powder application system, in the component of the powder application system, and/or adjacent the component of the powder application system. The powder application system cleaning device of the above-noted EXAMPLE where the ultrasonic horn is attached to a surface of a component of the powder application system by an adhesive, by welding, by mechanical fasteners, and/or by one or more magnets. The powder application system cleaning device of the above-noted EXAMPLE where the ultrasonic controller is configured to provide energy to the powder application system cleaning device to provide a controllable ultrasonic frequency to a surface of a component. The powder application system cleaning device of the above-noted EXAMPLE where the ultrasonic controller is configured to provide energy to the powder application system cleaning device to provide a varying or sweeping ultrasonic frequency to a surface of a component. The powder application system cleaning device of the above-noted EXAMPLE where the powder application system cleaning device is configured to apply ultrasonic energy to a surface of a component of the powder application system. The powder application system cleaning device of the above-noted EXAMPLE where the excitation device may include a piezoelectric transducer and/or a magnetostrictive transducer. The powder application system cleaning device of the above-noted EXAMPLE where the powder application system cleaning device may include a plurality of the powder application system cleaning device. The powder application system cleaning device of the above-noted EXAMPLE where the powder application system cleaning device is configured to be attached to any portion or component of a powder line. The powder application system cleaning device of the above-noted EXAMPLE where the powder application system cleaning device is configured to be attached to a powder cyclone separator of a powder recovery system. The powder application system cleaning device of the above-noted EXAMPLE where the powder application system cleaning device is configured to be attached to an intake duct of a powder recovery system.

One EXAMPLE includes: a powder application system cleaning device that includes an excitation device. The powder application system cleaning device in addition includes an ultrasonic horn. The powder application system cleaning device moreover includes an ultrasonic controller. The powder application system cleaning device also includes the excitation device being configured to discharge ultrasonic energy to components of the powder application system that will minimize powder accumulation and/or contamination.

The above-noted EXAMPLE may further include any one or a combination of more than one of the following EXAMPLES: The powder application system cleaning device of the above-noted EXAMPLE where the excitation device is configured to provide a continuously, a discretely, and/or a temporarily discharge of ultrasonic energy to components of the powder application system that will minimize powder accumulation and/or contamination. The powder application system cleaning device of the above-noted EXAMPLE where the powder application system may include a spray booth; and where the powder application system cleaning device is configured to be implemented in the spray booth. The powder application system cleaning device of the above-noted EXAMPLE where the powder application system cleaning device is attached to a roof of the spray booth. The powder application system cleaning device of the above-noted EXAMPLE where the powder application system cleaning device is attached to a floor of the spray booth. The powder application system cleaning device of the above-noted EXAMPLE where the powder application system cleaning device is attached to one or more walls of the spray booth. The powder application system cleaning device of the above-noted EXAMPLE where the powder application system cleaning device is attached to a roof of the spray booth; where the powder application system cleaning device is attached to a floor of the spray booth; and where the powder application system cleaning device is attached to one or more walls of the spray booth. The powder application system cleaning device of the above-noted EXAMPLE where the powder application system may include a powder supply hopper; and where the powder application system cleaning device is configured to be implemented in the powder supply hopper. The powder application system cleaning device of the above-noted EXAMPLE where the powder application system cleaning device is configured to be attached to a hopper wall of the powder supply hopper. The powder application system cleaning device of the above-noted EXAMPLE where the powder application system cleaning device is configured to be attached to a lid of the powder supply hopper. The powder application system cleaning device of the above-noted EXAMPLE where the powder application system may include a powder feed center; and where the powder application system cleaning device is configured to be implemented in the powder feed center. The powder application system cleaning device of the above-noted EXAMPLE where the powder application system may include a filter device; and where the powder application system cleaning device is configured to be implemented in the filter device. The powder application system cleaning device of the above-noted EXAMPLE where the ultrasonic horn is located on a component of the powder application system, in the component of the powder application system, and/or adjacent the component of the powder application system. The powder application system cleaning device of the above-noted EXAMPLE where the ultrasonic horn is attached to a surface of a component of the powder application system by an adhesive, by welding, by mechanical fasteners, and/or by one or more magnets. The powder application system cleaning device of the above-noted EXAMPLE where the powder application system cleaning device is configured to apply ultrasonic energy to a surface of a component of the powder application system. The powder application system cleaning device of the above-noted EXAMPLE where the excitation device may include a piezoelectric transducer and/or a magnetostrictive transducer. The powder application system cleaning device of the above-noted EXAMPLE where the ultrasonic controller is configured to provide energy to the powder application system cleaning device to provide a controllable ultrasonic frequency to a surface of a component. The powder application system cleaning device of the above-noted EXAMPLE where the ultrasonic controller is configured to provide energy to the powder application system cleaning device to provide a varying or sweeping ultrasonic frequency to a surface of a component. The powder application system cleaning device of the above-noted EXAMPLE where the powder application system cleaning device may include a plurality of the powder application system cleaning device. The powder application system cleaning device of the above-noted EXAMPLE where the powder application system cleaning device is configured to be attached to any portion or component of a powder line. The powder application system cleaning device of the above-noted EXAMPLE where the powder application system cleaning device is configured to be attached to a powder cyclone separator of a powder recovery system. The powder application system cleaning device of the above-noted EXAMPLE where the powder application system cleaning device is configured to be attached to an intake duct of a powder recovery system.

One EXAMPLE includes: a process that includes providing an excitation device. The process in addition includes configuring the excitation device to discharge ultrasonic energy to components of the powder application system that will minimize powder accumulation and/or contamination.

The above-noted EXAMPLE may further include any one or a combination of more than one of the following EXAMPLES: The process of the above-noted EXAMPLE where the excitation device is configured to provide a continuously, a discretely, and/or a temporarily discharge of ultrasonic energy to components of the powder application system that will minimize powder accumulation and/or contamination. The process of the above-noted EXAMPLE where the powder application system may include a spray booth; and where the powder application system cleaning device is configured to be implemented in the spray booth. The process of the above-noted EXAMPLE where the powder application system cleaning device is attached to a roof of the spray booth. The process of the above-noted EXAMPLE where the powder application system cleaning device is attached to a floor of the spray booth. The process of the above-noted EXAMPLE where the powder application system cleaning device is attached to one or more walls of the spray booth. The process of the above-noted EXAMPLE where the powder application system cleaning device is attached to a roof of the spray booth; where the powder application system cleaning device is attached to a floor of the spray booth; and where the powder application system cleaning device is attached to one or more walls of the spray booth. The process of the above-noted EXAMPLE where the powder application system may include a powder supply hopper; and where the powder application system cleaning device is configured to be implemented in the powder supply hopper. The process of the above-noted EXAMPLE where the powder application system cleaning device is configured to be attached to a hopper wall of the powder supply hopper. The process of the above-noted EXAMPLE where the powder application system cleaning device is configured to be attached to a lid of the powder supply hopper. The process of the above-noted EXAMPLE where the powder application system may include a powder feed center; and where the powder application system cleaning device is configured to be implemented in the powder feed center. The process of the above-noted EXAMPLE where the powder application system may include a filter device; and where the powder application system cleaning device is configured to be implemented in the filter device. The process of the above-noted EXAMPLE may include: an ultrasonic horn; and an ultrasonic controller. The process of the above-noted EXAMPLE where the ultrasonic horn is located on a component of the powder application system, in the component of the powder application system, and/or adjacent the component of the powder application system. The process of the above-noted EXAMPLE where the ultrasonic horn is attached to a surface of a component of the powder application system by an adhesive, by welding, by mechanical fasteners, and/or by one or more magnets. The process of the above-noted EXAMPLE where the ultrasonic controller is configured to provide energy to the powder application system cleaning device to provide a controllable ultrasonic frequency to a surface of a component. The process of the above-noted EXAMPLE where the ultrasonic controller is configured to provide energy to the powder application system cleaning device to provide a varying or sweeping ultrasonic frequency to a surface of a component. The process of the above-noted EXAMPLE where the powder application system cleaning device is configured to apply ultrasonic energy to a surface of a component of the powder application system. The process of the above-noted EXAMPLE where the excitation device may include a piezoelectric transducer and/or a magnetostrictive transducer. The process of the above-noted EXAMPLE where the powder application system cleaning device may include a plurality of the powder application system cleaning device. The process of the above-noted EXAMPLE where the powder application system cleaning device is configured to be attached to any portion or component of a powder line. The process of the above-noted EXAMPLE where the powder application system cleaning device is configured to be attached to a powder cyclone separator of a powder recovery system. The process of the above-noted EXAMPLE where the powder application system cleaning device is configured to be attached to an intake duct of a powder recovery system.

One EXAMPLE includes: a process that includes providing an excitation device. The process in addition includes providing an ultrasonic horn. The process moreover includes providing an ultrasonic controller. The process also includes configuring the excitation device to discharge ultrasonic energy to components of the powder application system that will minimize powder accumulation and/or contamination.

The above-noted EXAMPLE may further include any one or a combination of more than one of the following EXAMPLES: The process of the above-noted EXAMPLE where the excitation device is configured to provide a continuously, a discretely, and/or a temporarily discharge of ultrasonic energy to components of the powder application system that will minimize powder accumulation and/or contamination. The process of the above-noted EXAMPLE where the powder application system may include a spray booth; and where the powder application system cleaning device is configured to be implemented in the spray booth. The process of the above-noted EXAMPLE where the powder application system cleaning device is attached to a roof of the spray booth. The process of the above-noted EXAMPLE where the powder application system cleaning device is attached to a floor of the spray booth. The process of the above-noted EXAMPLE where the powder application system cleaning device is attached to one or more walls of the spray booth. The process of the above-noted EXAMPLE where the powder application system cleaning device is attached to a roof of the spray booth; where the powder application system cleaning device is attached to a floor of the spray booth; and where the powder application system cleaning device is attached to one or more walls of the spray booth. The process of the above-noted EXAMPLE where the powder application system may include a powder supply hopper; and where the powder application system cleaning device is configured to be implemented in the powder supply hopper. The process of the above-noted EXAMPLE where the powder application system cleaning device is configured to be attached to a hopper wall of the powder supply hopper. The process of the above-noted EXAMPLE where the powder application system cleaning device is configured to be attached to a lid of the powder supply hopper. The process of the above-noted EXAMPLE where the powder application system may include a powder feed center; and where the powder application system cleaning device is configured to be implemented in the powder feed center. The process of the above-noted EXAMPLE where the powder application system may include a filter device; and where the powder application system cleaning device is configured to be implemented in the filter device. The process of the above-noted EXAMPLE where the ultrasonic horn is located on a component of the powder application system, in the component of the powder application system, and/or adjacent the component of the powder application system. The process of the above-noted EXAMPLE where the ultrasonic horn is attached to a surface of a component of the powder application system by an adhesive, by welding, by mechanical fasteners, and/or by one or more magnets. The process of the above-noted EXAMPLE where the powder application system cleaning device is configured to apply ultrasonic energy to a surface of a component of the powder application system. The process of the above-noted EXAMPLE where the excitation device may include a piezoelectric transducer and/or a magnetostrictive transducer. The process of the above-noted EXAMPLE where the ultrasonic controller is configured to provide energy to the powder application system cleaning device to provide a controllable ultrasonic frequency to a surface of a component. The process of the above-noted EXAMPLE where the ultrasonic controller is configured to provide energy to the powder application system cleaning device to provide a varying or sweeping ultrasonic frequency to a surface of a component. The process of the above-noted EXAMPLE where the powder application system cleaning device may include a plurality of the powder application system cleaning device. The process of the above-noted EXAMPLE where the powder application system cleaning device is configured to be attached to any portion or component of a powder line. The process of the above-noted EXAMPLE where the powder application system cleaning device is configured to be attached to a powder cyclone separator of a powder recovery system. The process of the above-noted EXAMPLE where the powder application system cleaning device is configured to be attached to an intake duct of a powder recovery system.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto another element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over another element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to another element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

The many features and advantages of the disclosure are apparent from the detailed specification, and, thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

1. A powder application system cleaning device configured to be implemented in components of a powder application system, the powder application system cleaning device comprising:
an excitation device; and
the excitation device being configured to discharge ultrasonic energy to components of the powder application system that will minimize powder accumulation and/or contamination.

2. The powder application system cleaning device according to claim 1 wherein the excitation device is configured to provide a continuously, a discretely, and/or a temporarily discharge of ultrasonic energy to components of the powder application system that will minimize powder accumulation and/or contamination.

3. The powder application system cleaning device according to claim 1 wherein the powder application system comprises a spray booth; and wherein the powder application system cleaning device is configured to be implemented in the spray booth.

4. The powder application system cleaning device according to claim 1 wherein the powder application system comprises a powder supply hopper; and wherein the powder application system cleaning device is configured to be implemented in the powder supply hopper.

5. The powder application system cleaning device according to claim 1 wherein the powder application system comprises a powder feed center; and wherein the powder application system cleaning device is configured to be implemented in the powder feed center.

6. The powder application system cleaning device according to claim 1 wherein the powder application system comprises a filter device; and wherein the powder application system cleaning device is configured to be implemented in the filter device.

7. The powder application system cleaning device according to claim 1 further comprising:
an ultrasonic horn; and
an ultrasonic controller.

8. The powder application system cleaning device according to claim 7 wherein the ultrasonic horn is located on a component of the powder application system, in the component of the powder application system, and/or adjacent the component of the powder application system.

9. The powder application system cleaning device according to claim 7 wherein the ultrasonic horn is attached to a surface of a component of the powder application system by an adhesive, by welding, by mechanical fasteners, and/or by one or more magnets.

10. The powder application system cleaning device according to claim 1 wherein the powder application system cleaning device is configured to apply ultrasonic energy to a surface of a component of the powder application system.

11. The powder application system cleaning device according to claim 1 wherein the excitation device comprises a piezoelectric transducer and/or a magnetostrictive transducer.

12. The powder application system cleaning device according to claim 7 wherein the ultrasonic controller is configured to provide energy to the powder application system cleaning device to provide a controllable ultrasonic frequency to a surface of a component.

13. The powder application system cleaning device according to claim 7 wherein the ultrasonic controller is configured to provide energy to the powder application system cleaning device to provide a varying or sweeping ultrasonic frequency to a surface of a component.

14. The powder application system cleaning device according to claim 1 wherein the powder application system cleaning device comprises a plurality of the powder application system cleaning device.

15. The powder application system cleaning device according to claim 3 wherein the powder application system cleaning device is attached to at least one of a roof of the spray booth, a floor of the spray booth, and/or one or more walls of the spray booth.

16.-18. (canceled)

19. The powder application system cleaning device according to claim 4 wherein the powder application system cleaning device is configured to be attached to at least one of a hopper wall of the powder supply hopper and/or a lid of the powder supply hopper.

20. (canceled)

21. The powder application system cleaning device according to claim 1 wherein the powder application system cleaning device is configured to be attached to any portion or component of a powder line.

22. The powder application system cleaning device according to claim 1 wherein the powder application system cleaning device is configured to be attached to a powder cyclone separator of a powder recovery system.

23. The powder application system cleaning device according to claim 1 wherein the powder application system cleaning device is configured to be attached to an intake duct of a powder recovery system.

24.-45. (canceled)

46. A process of implementing a powder application system cleaning device in components of a powder application system, the process of implementing a powder application system cleaning device comprising:
providing an excitation device; and
configuring the excitation device to discharge ultrasonic energy to components of the powder application system that will minimize powder accumulation and/or contamination.

47.-90. (canceled)
